(19) United States
(12) Patent Application Publication
(10) Pub. No.: US 2009/0004997 A1
(43) Pub. Date: Jan. 1, 2009

(54) Portable emergency call center

(76) Inventors: Danny A. Allen, Sammamish, WA (US); Donald L. Mitchell, JR., Bellevue, WA (US)

Correspondence Address: MANELLI DENISON & SELTER PLLC, 7th Floor, 2000 M Street, N.W., Washington, DC, 20036-3307, US

(21) Appl. No.: 12/007,510

(22) Filed: Jan. 11, 2008

Related U.S. Application Data
(60) Provisional application No. 60/929,445, filed on Jun. 27, 2007.

(51) Int. Cl. H04M 11/04

(52) U.S. Cl. 455/404.1

(57) ABSTRACT

A generic portable PSAP comprises a field satellite link, a network element, an Internet Protocol (IP) based PSAP switch, and customer premises equipment. The generic portable PSAP is an end-to-end portable emergency call center that local and VoIP carriers can use to connect to a new “temporary” PSAP in emergency situations where a given PSAP is unable to function in its normal facility. The portable emergency call center routes and receives emergency services events from landline, voice over Internet Protocol (VoIP), and/or wireless carriers without need for customization from a given network architecture. The generic portable PSAP enables local management of emergency event acquisition and dispatch in the case of a major disaster, or some other reason for use of a mobile PSAP.

This application claims priority from U.S. Provisional Application No. 60/929,445, to Allen et al., filed Jun. 27, 2007, entitled “Portable Emergency Call Center”, the entirety of which is explicitly incorporated herein by reference.

### BACKGROUND OF THE INVENTION

1. Field of the Invention

This invention relates generally to telecommunications. More particularly, it relates to location based services (LBS) and wireless emergency services such as E911.

2. Background of the Related Art

9-1-1 is a phone number widely recognized in North America as an emergency phone number that is used to contact emergency dispatch personnel. Enhanced 9-1-1 (E9-1-1) is defined by an emergency call being selectively routed to an appropriate PSAP, based on a special identifier (P-ANI, or “Pseudo Automatic Number Identifier”, also referred to as “ESxK”), and includes the transmission of callback number and location information when 9-1-1 is used. E9-1-1 may be implemented for landline, cellular or VoIP networks. A Public Service Answering Point (PSAP) is a dispatch office that receives 9-1-1 calls from the public. A PSAP may be a local, fire or police department, an ambulance service or a regional office covering all services. As used herein, the term “PSAP” refers to either a public safety access point (PSAP), or to an Emergency Call Center (ECC), a VoIP term.

Regardless of the network type, a 9-1-1 service becomes E-9-1-1 when automatic number identification and automatic location information related to the call is provided to the 9-1-1 operator at the PSAP. A primary challenge results from the fact that calls may arrive at the PSAP without the caller's actual callback number or location information displayed at the emergency operator's terminal.

The current 911 infrastructure is designed to route a live voice call to a local public safety answering point (PSAP). This requires that voice circuits be available. The result of an E911 call is a direct circuit switched voice connection between an emergency service requestor and a suitable responder. 911 is further enhanced with the ability to deliver location over a data channel in parallel to the call. The location data is typically staged in a database that is queried by the PSAP to determine location information.

FIG. 7 shows a conventional landline public safety access point (PSAP) to automatic location identifier (ALI) connection.

In particular, FIG. 7 shows a PSAP 400 connected to one Automatic Location Identifier (ALI) database 401. Upon receiving a 9-1-1 call, the PSAP 400 queries the ALI 401 for location data. The ALI database 401 accepts the query from the PSAP 400 for location. The query includes the telephone number of an emergency caller. The ALI database 401 relates the received telephone number to a physical street address and provides that street address (location information) back to the PSAP 400 in a manner that works for the customer premise equipment (CPE) display at the PSAP 400.

An ALI is typically owned by a local exchange carrier (LEC) or a PSAP, and may be regional (i.e. connected to many PSAPs) or standalone (i.e. connected to only one PSAP). There is currently no one single standard interface protocol for PSAP-ALI connection/communication.

FIG. 8 shows a context diagram for a conventional non-landline positioning center (e.g., an Internet based voice over Internet Protocol (VoIP) positioning center).

In particular, the ALI database 401 includes a conventional emergency services key (ESQK or ESRK) in a location request sent to an appropriate positioning center 402 (XPC). The emergency services key (ESQK or ESRK) is used by the positioning center 402 as a key to look up the location and other call information associated with the emergency call.

In non-landline telephony, the PSAPs 400 query the ALI 401 for location information. However, the ALI 401 is not pre-provisioned with location data for non-landline calls (e.g. cellular, VoIP etc) and must communicate with other network entities to obtain and deliver location data to the PSAP 400.

Non-landline telephony standards (e.g. cellular, VoIP etc) have mandated that ALIs 401 maintain connectivity to a positioning center 402 that is able to provide current location data for a non-landline call. In the current state of technology, the positioning center 402 provides the caller's location and the callback number to the ALI, which passes it to the requesting PSAP. As can be seen in FIG. 8, an ALI may maintain connectivity to more than one positioning center via multiple interface types—both standard and non-standard (e.g. NENA-02, E2/E2+N-E2(ESP), PAM, etc.).

As used herein, the generic term “XPC” refers interchangeably to any standards-based positioning center. As examples, a positioning center 402 may be any one of the following types used in non-landline networks:
GMLC (Gateway Mobile Location Center): The positioning center that retrieves, forwards, stores and controls emergency position data within the GSM location network.
MPC (Mobile Position Center): The positioning center that retrieves, forwards, stores and controls emergency position data within the ANSI location network.
VPC (VoIP Positioning Center): The positioning center which retrieves, forwards, stores and controls emergency position data within the VoIP location network.

The term “XPC network” is used herein when appropriate to refer to any non-landline network where a positioning center 402 responds to ALI queries including an emergency services key for location, e.g., cellular, VoIP etc.

911 calls require voice circuits to be available to complete the voice call to a PSAP. For the most part, PSAPs are capable of receiving only voice calls. Connectivity with a PSAP, established either through the existing time division multiplexed (TDM)-based emergency services network (ESN), or directly over the public switched telephone network (PSTN) to the PSAP, is managed through dedicated telephone switches that cannot be directly dialed.

The present inventors have appreciated that during times of regional crises, such as during a hurricane, the local wireless infrastructure can become overloaded by call volume. This was experienced during the Sep. 11, 2001, terrorist attacks during which voice telecommunications along the east coast was subjected to service failures.

There is a long-felt need for improving emergency communications to provide a generic end-to-end system providing reliable emergency services during times of regional crisis.

### SUMMARY OF THE INVENTION

In accordance with the principles of the present invention, a portable Public Safety Access Point (PSAP) comprises an Internet Protocol (IP) input, and a field satellite link to receive an emergency call via the Internet Protocol (IP) input. An IP based PSAP switch receives the emergency call received by the field satellite link, and customer premises equipment (CPE) allows an emergency call center operator to handle the emergency call routed by the IP based PSAP switch to the CPE.

In accordance with another aspect of the invention, a method of providing a temporary Public Safety Access Point (PSAP) for use with landline, wireless and voice over Internet Protocol (VoIP) emergency callers comprises receiving an emergency call over an Internet Protocol (IP) interface. A field satellite link receives the emergency call via the Internet Protocol (IP) interface. The emergency call received by the field satellite link is routed to an IP based PSAP switch, and presented to an operator at customer premises equipment (CPE) associated with the temporary PSAP.

### BRIEF DESCRIPTION OF THE DRAWINGS

Features and advantages of the present invention will become apparent to those skilled in the art from the following description with reference to the drawings:

FIG. 1 shows a generic portable PSAP usable as a temporary PSAP for handling emergency calls from landline, wireless and VoIP callers, in accordance with the principles of the present invention.

FIG. 2 shows a landline portable PSAP scenario using a generic portable PSAP shown in FIG. 1 to handle an emergency 911 call initiated by a landline phone, in accordance with the principles of the present invention.

FIG. 3 shows a wireless portable PSAP scenario using a generic portable PSAP shown in FIG. 1 to handle an emergency 911 call initiated by a wireless phone, in accordance with the principles of the present invention.

FIG. 4 shows a VoIP scenario using a generic portable PSAP shown in FIG. 1 to handle an emergency 911 call initiated by a VoIP caller, in accordance with the principles of the present invention.

### DETAILED DESCRIPTION OF ILLUSTRATIVE EMBODIMENTS

Portable PSAP solutions are conventionally customized for a given situation, with customized interfaces and elements. The present invention provides an end-to-end portable emergency call center that is generic in design for use with any of landline, wireless and/or VoIP emergency 911 callers. Using the generic portable PSAP in accordance with the principles of the present invention, virtually any local or VoIP carrier can be connected to a new “temporary” PSAP in emergency situations where a given PSAP (or PSAPs) is unable to function in its normal facility.

Thus, the disclosed generic portable emergency call center routes and receives emergency services events from landline, voice over Internet Protocol (VoIP), and/or wireless carriers without need for customization from a given network architecture. The disclosed embodiments enable local management of emergency event acquisition and dispatch in the case of a major disaster, or some other reason for use of a mobile PSAP.

The present invention solves the conventional problem often seen in an emergency situation where a public safety answering point (PSAP) is unable to function in its normal facility generally due to a large scale emergency. It does this by providing a generic, portable or “temporary” PSAP for connection by local and VoIP carriers.

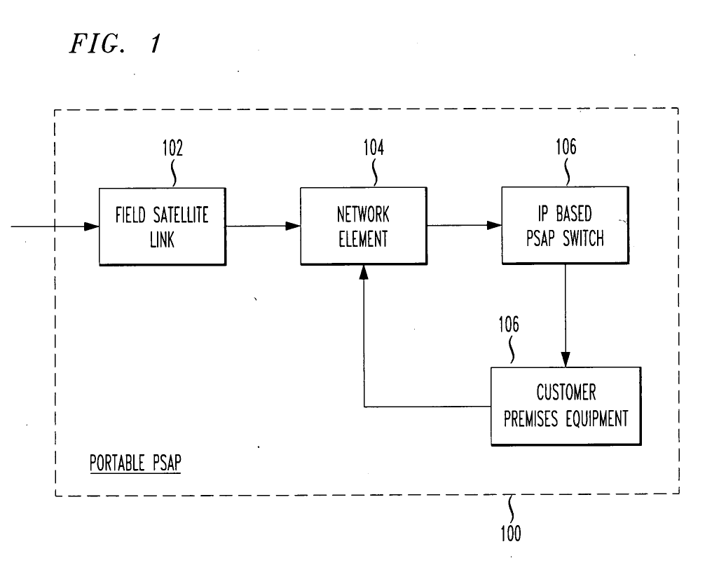

FIG. 1 shows a generic portable PSAP usable as a temporary PSAP for handling emergency calls from landline, wireless and VoIP callers, in accordance with the principles of the present invention.

In particular, as shown in FIG. 1, a generic portable PSAP is formed using a field satellite link 102, a network element 104, an Internet Protocol (IP) based PSAP switch 106, and customer premises equipment 106.

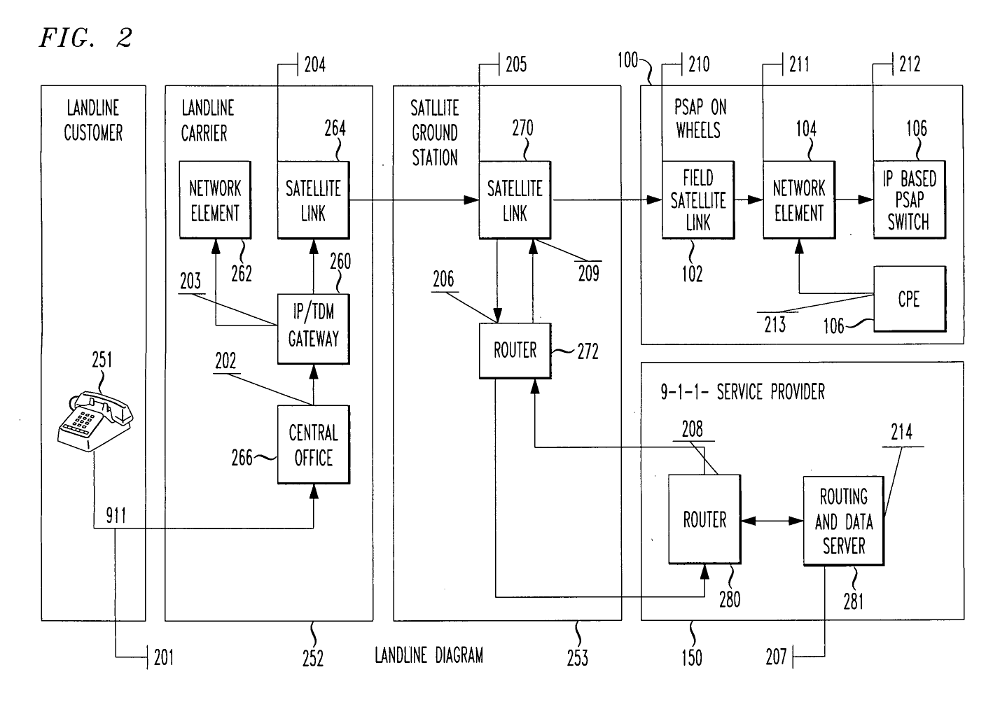

FIG. 2 shows a landline portable PSAP scenario using a generic portable PSAP shown in FIG. 1 to handle an emergency 911 call initiated by a landline phone, in accordance with the principles of the present invention.

In particular, as shown in step 201 of FIG. 2, a landline customer 251 dials 9-1-1.

In step 202, the local exchange carrier switch 266 picks up the landline call and egresses the call to an Internet Protocol/Time Division Multiplexing Gateway (IP/TDM Gateway) 260.

In step 203, this IP/TDM gateway 260 converts the TDM signaling (e.g. ISUP) to Internet Protocol (IP) using the Session Initiation Protocol (SIP). Within the SIP signaling, is a MIME body part that indicates (a) the originating switch identity, (b) the carrier, and (c) an indication of the destination of the generic portable (temporary) PSAP 100.

In step 204, the signaling from the IP/TDM Gateway 260 is then sent out over an IP network directly or over a satellite link 270 (as shown in the diagram).

In step 205, if sent over satellite, then the signaling is picked up by a satellite ground station 253 and sent over an Internet Protocol (IP) network to the generic portable PSAP 100.

In step 206, the signaling is routed to a router 280 at the 9-1-1 Service Provider's IP network 150.

In step 207, the signaling is handled by the 9-1-1 service provider's Routing and Data Server 281 to provide proper route signaling for the call to reach the designated generic portable PSAP (e.g., PSAP on Wheels) 100.

In step 208, this signaling is sent from the 9-1-1 service provider 150 over Internet Protocol (IP) to a satellite ground station router 272.

In step 209, the signaling is sent out over the satellite network.

In step 210, the signaling reaches a field satellite link (i.e., receiver) 102 at the generic portable PSAP 100, in accordance with the principles of the present invention. Preferably, the interface to the field satellite link 102 of the generic portable PSAP 100 is a TCP/IP communication link.

In step 211, a network element (e.g., a router) 104 in the generic portable PSAP 100 passes the call signaling to an IP based PSAP switch 106.

In step 212, the voice relating to the emergency call is now connected to an operator using the customer premises equipment (CPE) 106 at the generic portable PSAP 100.

In step 213, customer premises equipment (CPE) 106 associated with the generic portable PSAP 100 generates an Automated Location Identification (ALI) query.

In step 214, the ALI query is serviced by the Routing and Data Server 281 of the 9-1-1 Service Provider 150

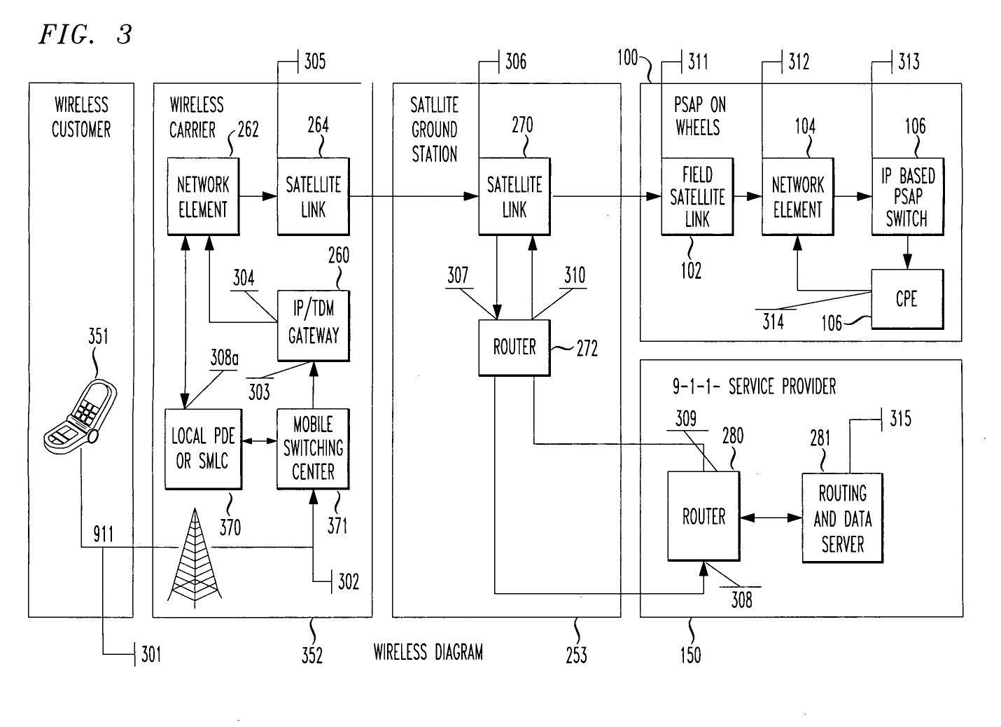

FIG. 3 shows a wireless portable PSAP scenario using a generic portable PSAP 100 shown in FIG. 1 to handle an emergency 911 call initiated by a wireless phone 351, in accordance with the principles of the present invention.

In particular, as shown in step 301 of FIG. 3, a wireless customer 351 dials 9-1-1.

In step 302, the local wireless carrier base station 352 picks up the 911 call and delivers it to a mobile telephone switching office (MTSO) or Mobile Switching Center (MSC) 371.

In step 303, the Mobile Switching Center (MSC) 371 egresses the 911 call to an Internet Protocol/Time Division Multiplexing Gateway (IP/TDM Gateway) 260.

In step 304, this IP/TDM gateway 260 converts the TDM signaling (e.g. ISUP) to IP using Session Initiation Protocol (SIP). Within the SIP signaling is a MIME body part that indicates (a) the originating MSC identity, (b) the carrier, and (c) an indication of the destination of the generic portable (temporary) PSAP 100.

In step 305, signaling from the IP/TDM gateway 260 is then sent out over an IP network directly or over satellite (as shown in the diagram).

In step 306, if sent over satellite, then the signaling is picked up by a satellite ground station 253 and sent over an Internet Protocol (IP) network.

In step 307, the signaling is routed to a router 280 at the 9-1-1 service provider's IP network 150.

In step 308, the signaling is handled by the 9-1-1 service provider's Routing and Data Server 281 to provide proper route signaling for the call to reach the designated generic portable PSAP 100.

When necessary the Routing and Data Server 281 also initiates a request for the precise location of the wireless caller 351 from the wireless carrier's Positioning Determination Element (PDE) or their Serving Mobile Location Center (SMLC) 370.

In step 309, this signaling is sent from the 9-1-1 service provider 150 over IP to a satellite ground station router 272.

In step 310, the signaling is sent out over the satellite network.

In step 311, the signaling reaches a field satellite link (receiver) 102 at the generic portable PSAP 100.

In step 312, a network element (e.g., a router) 104 in the generic portable PSAP 100 passes the call signaling to an IP based PSAP switch 106.

In step 313, the voice relating to the emergency 911 call is now connected to an operator of customer premises equipment (CPE) 106 at the generic portable PSAP 100.

In step 314, customer premises equipment (CPE) 106 at the generic portable PSAP 100 generates an Automated Location Identification (ALI) query.

In step 315, the ALI query is serviced by the Routing and Data Server 281 at the 9-1-1 service provider 150.

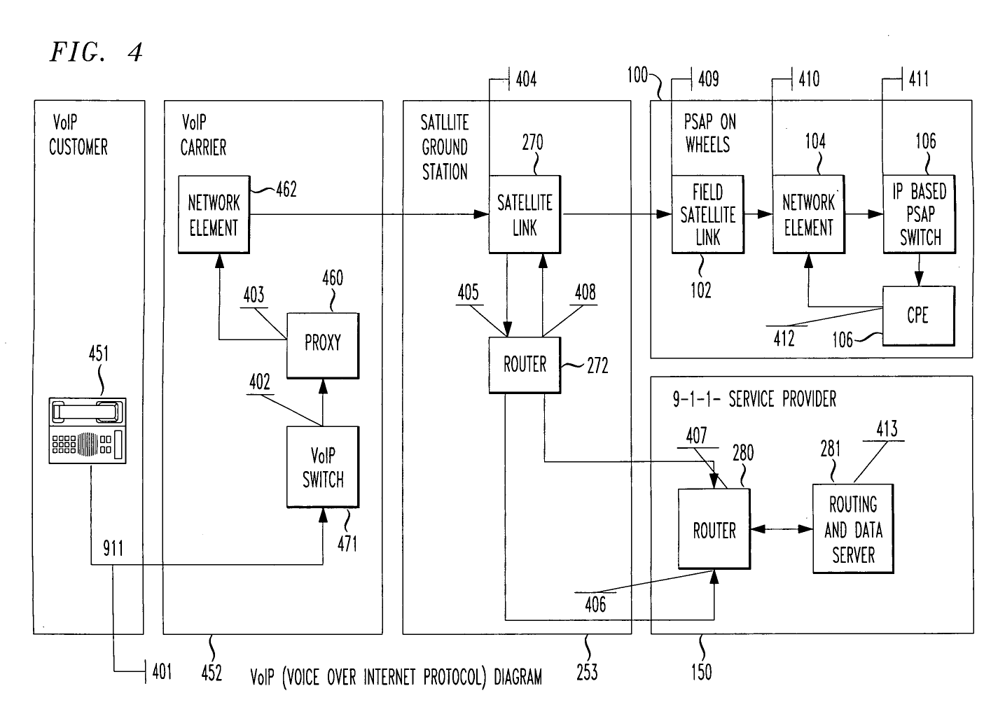

FIG. 4 shows a VoIP scenario using a generic portable PSAP 100 shown in FIG. 1 to handle an emergency 911 call initiated by a VoIP caller, in accordance with the principles of the present invention.

In particular, as shown in step 401 of FIG. 4, a VoIP customer 451 dials 9-1-1.

In step 402, the 911 emergency call traverses the carrier's VoIP switch 471 as is otherwise conventional toward their 9-1-1 service provider 150.

In step 403, the 911 call may traverse a proxy 460 before traversing the network to the 9-1-1 service provider 150.

In step 404, the signaling is then sent out over an IP network directly or over a satellite link 270 (if necessary, as shown in the diagram).

In step 405, if sent over a satellite link 270, then the signaling is picked up by a satellite ground station 253 and sent over an Internet Protocol (IP) network.

In step 406, the signaling is routed to a router 280 at the 9-1-1 service provider's IP network. The signaling is handled by the Routing and Data Server 281 at the 9-1-1 service provider 150 to provide proper route signaling for the call to reach the designated generic portable PSAP 100.

In step 407, this signaling is sent from the 9-1-1 service provider 150 back to the router 272 of the satellite ground station 253 or IP network.

In step 408, the signaling is sent out over an Internet Protocol connection to the satellite link 270.

In step 409, the signaling is sent to the field satellite link (receiver) 102 at the generic portable PSAP 100.

In step 410, the network element (e.g., a router) 104 in the generic portable PSAP 100 passes the call signaling to the IP based generic portable PSAP 100.

In step 411, the voice relating to the emergency 911 call is now connected to an operator at customer premises equipment (CPE) 106 at the generic portable PSAP 100.

In step 412, customer premises equipment (CPE) 106 at the generic portable PSAP 100 generates an Automated Location Identification (ALI) query.

In step 413, the ALI query is serviced by the Routing and Data Server 281 at the 9-1-1 service provider 150.

A generic, portable emergency call center (e.g., PSAP) 100 in accordance with the principles of the present invention may be implemented on a voice over Internet Protocol (VoIP) network, e.g., over satellite, but in all cases via a TCP/IP connection, to provide a mobile call center.

The present invention enables local management of emergency event acquisition and dispatch in the case of a major disaster, or some other reason for use of a mobile public safety answering point (PSAP).

Applications of the invention include use by states (e.g., PSAP coordinators for PSAPs), counties (e.g., PSAP coordinators for PSAPs), cities (e.g., emergency services coordinators for PSAPs), and/or federal emergency management agency (FEMA).

While the invention has been described with reference to the exemplary embodiments thereof, those skilled in the art will be able to make various modifications to the described embodiments of the invention without departing from the true spirit and scope of the invention.

What is claimed is:

1. A portable Public Safety Access Point (PSAP), comprising:
an Internet Protocol (IP) input;
a field satellite link to receive an emergency call via said Internet Protocol (IP) input;
an IP based PSAP switch to receive said emergency call received by said field satellite link; and
customer premises equipment (CPE) allowing an emergency call center operator to handle said emergency call routed by said IP based PSAP switch to said CPE.

2. The portable Public Safety Access Point (PSAP) according to claim 1, wherein:
said IP input includes a TCP/IP interface.

3. The portable Public Safety Access Point (PSAP) according to claim 1, further comprising:
a network element interposed between said field satellite link and said IP based PSAP switch.

4. The portable Public Safety Access Point (PSAP) according to claim 3, wherein:
said network element is a router.

5. The portable Public Safety Access Point (PSAP) according to claim 4, wherein:
said router is a voice over Internet Protocol (VoIP) based router.

6. A method of providing a temporary Public Safety Access Point (PSAP) for use with landline, wireless and voice over Internet Protocol (VoIP) emergency callers, comprising:
receiving an emergency call over an Internet Protocol (IP) interface;
a field satellite link receiving said emergency call via said Internet Protocol (IP) interface;
routing said emergency call received by said field satellite link to an IP based PSAP switch; and
presenting said emergency call to an operator at customer premises equipment (CPE) associated with said temporary PSAP.

7. The method of providing a temporary Public Safety Access Point (PSAP) for use with landline, wireless and voice over Internet Protocol (VoIP) emergency callers according to claim 6, wherein:
said IP input includes a TCP/IP interface.

8. The method of providing a temporary Public Safety Access Point (PSAP) for use with landline, wireless and voice over Internet Protocol (VoIP) emergency callers according to claim 6, further comprising:
interposing a network element between said field satellite link and said IP based PSAP switch.

9. The method of providing a temporary Public Safety Access Point (PSAP) for use with landline, wireless and voice over Internet Protocol (VoIP) emergency callers according to claim 8, wherein:
said network element is a router.

10. The method of providing a temporary Public Safety Access Point (PSAP) for use with landline, wireless and voice over Internet Protocol (VoIP) emergency callers according to claim 9, wherein:
said router is a voice over Internet Protocol (VoIP) based router.
